(19) United States
(12) Patent Application Publication
(10) Pub. No.: US 2007/0197261 A1
(43) Pub. Date: Aug. 23, 2007

(54) Mobile Telephone All In One Remote Key Or Software Regulating Card For Radio Bicycle Locks, Cars, Houses, And Rfid Tags, With Authorisation And Payment Function

(76) Inventor: Roger Marcel Humbel, Baden (CH)

Correspondence Address: BREINER & BREINER, L.L.C., P.O. BOX 19290, ALEXANDRIA, VA, 22320-0290, US

(21) Appl. No.: 10/593,323

(22) PCT Filed: Mar. 16, 2005
(86) PCT No.: PCT/CH05/00158

§ 371 Date: Oct. 19, 2006

(30) Foreign Application Priority Data
Mar. 19, 2004 (CH) 436/05

(51) Int. Cl. H04B 1/38

(52) U.S. Cl. 455/558

(57) ABSTRACT

The “All In One Remote Keys” (AIORK) for (GSM, UMTS, W-LAN, Bluetooth, RFID-transceiver) mobile phones and/or extension kits is a universal key for all kind of locks, gates or entrances and it has a direct payment- and clearing function for electronic (Bluetooth, WLan, GSM and esp. NFC RFID-) cash payments for all consumed accesses, services or information. The input can be made by fingerprint or oral with direct biometric sensor confirmation. The NFC transceiver is for: Info-download, direct-cash-payment, access-control, function control, authentification of internet-auctions, -betting and -stock transactions and of such information and over all for RFID-tag identification of worthy objects, electronic devices and parts etc. with GSM based Internet website or account clearing. And it is running and lets manage a mobile-phone-platform with video-clip-hitcharts, which is with fingerprint-sensor authentication the best quality bringing solution for e.g. news etc. looking mobile video phone user/consumer and which is so finally the only functioning or establishing mobile video phone solution.

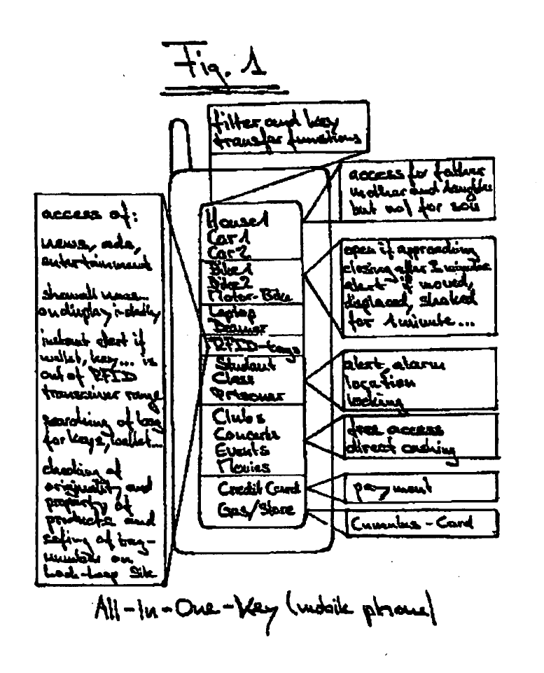

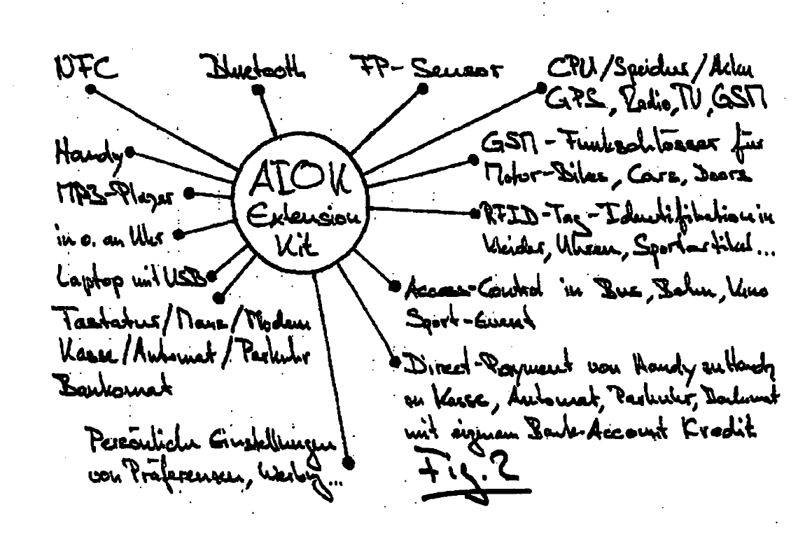

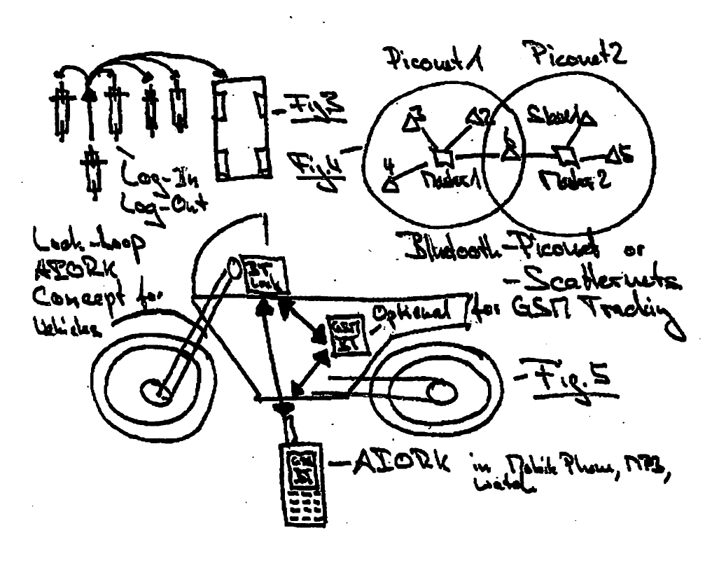

### TECHNICAL AREA INTRODUCTION/SUMMARY

The “All In One Remote Key” (AIORK) is a mobile handset device (as key) with multiple transceivers (GSM, Bluetooth, NFC, W-LAN) and with a fingerprint-sensor (access, code, number, password, ID, authentification, authorisation, buy/purchase, sale, payment, control of function) for direct assessment and access on a interactive Internet- or mobile-phone-platform (with video hit-lists or hit-charts, content, television-channel, game, service, product, software-implementation, authorisations, polls, rights and duties, partner-meeting, stock-, bet-, business- and payment control features) in one mobile phone or in one extension kit, in one software and in one list for opening, access, use (for among several keys, i.e. for a part-function (e.g. only vibra-alarm in movies, only SMS, filter-functions, adds etc.)), additional information, authorisation and tracking for one or several radio-locks (for bicycles, vehicles, homes) or keys simultaneously or not (i.e. for the whole garage or only for the vehicle etc.) and for mobile payments as well as for RFID-tag- and for other such new applications.

### INNOVATION AND NOVELTY

Up to date there is/exists no camera mobile phone and spy-safe solution for mobile payments, access-control and radio-lock applications. Over all there was no one single solution available for the (from us) in multiple different versions designed new GSM and Bluetooth radio locks for bicycles, motorcycles and trucks or doors for garages as one single key, which provided also mobile payments over NFC and or with fingerprintsensors with direct or indirect GSM transferred clearing on bank-accounts. Another for mobile phones with NFC running application for RFID-tag identification for registration of ones property with such RFID-tags was not invented and claimed yet. Over all also not yet available is that this application runs together with the other new over fingerprintsensor authentification also on NFC based mobile-payment and in radio-locks integrated bluetooth-modules bases applications, which all can be managed with one software over one list in one device.

### STATE OF THE ART

States of the Art are mobile phone keys over GSM or bluetooth transceivers as in following list I.e. following key-functions do exist already with mobile phones and can not be claimed individually with the AIORK patent, but of course all following new claimed “keys” etc. in combination with these here following already existing mobile phone based keys or programs etc.:
telephone calls
any other software downloads
games, lotteries, stock-exchange
video and music download
money, payment and cash transactions
911, 211 emergency calls
cars, garages and motor-bike.

The “All In One Remote Key” (AIORK) patent is for mobile phones or such software companies like Symbian, Openwave, Nokia or Siemens. The transaction input can be made with fingers or orally with direct biometric confirmation.

Since at least RFID-tag identification and direct-payment, parcel-delivery or access-control functions with biometric (fingerprint-) sensor and double second account-code (as direct-net) over NFC as well as all (GPS, GSM, Bluetooth) radio (bicycle) locks are for sure new, so is this feature of the AIORK for all vehicles et in one single mobile phone new as well as innovative and it makes very much sense, since it provides the exclusivity that only with one mobile phone all these different locks may be opened/unlocked or the NFC-direct-payment-, -access-control- and -RFID-applications with/over one mobile phone/device, one software or one list can be managed. —Who does like to have multiple mobile phones with himself to carry with for each one for each single application of these different new AIORK applications?

Such WAP mobile phones or extension kits did not yet exist with constant web-connection, which can open and lock radio-locks with Bluetooth transceivers or which are featured even with a NFC transceiver and a biometric fingerprint- or camera-sensor or speech-recognition-software. And there were never existing radio-locks with GSM-, Bluetooth, NFC and Infrared transceiver or mobile phones with NFC-RFID-tag reader for payment-applications. Though there were Bluetooth door systems for garages, but without Internet- or even GSM-connection and alarm-transmission or direct management (opening, locking, authorisation, selection for further services).

Also mobile phones or extension kits that RFID-tags or other NFC transceiver read or with other NFC transceivers do interact did not exist yet, over all not with biometric authentification with fingerprint-sensor and direct over a cable to them attached or to them connected keys (bundles) or remote central locking systems for cars!

NFC is “Near Field Communication” on 13.56 MHz frequency and like its name and definition does NFC can send only in a radius of about 10 cm range. A combination of mobile phone or extension kit with NFC or even Bluetooth and biometric (finger-print) sensor did not exist yet. A combination of mobile phone or extension kit with NFC or even Bluetooth and biometric (fingerprint-) sensor did not exist either, though this brings ultimate direct- or mobile payment etc. -advantages, because no spy transceivers like with Bluetooth can read the sensitive data.

### DEFINITION OF THE INNOVATION

Following features of all these new (Lock-Loop, RFID etc.) features in mobile phones or extension kits are claimed in this AIORK patent application:
for transmission and authorisation of a mobile phone-key-set on a AIORK mobile phone or extension kits of an other person
for downloads of the latest AIORK key-software (in case of that this Bluetooth transmission can be hacked and cracked
Bicycles with GPS, GSM and Bluetooth module
NFC/Bluetooth/W-LAN house-, garage- and room-doors or movie-, sport-event-, public transportation, parking lot- and parking house- etc. gates with direct payment-clearing like with Visa-/Master-Card etc. or bank teller-machine.
Identification of NFC (Bluetooth, W-LAN, GSM, UMTS) RFID-tags in bindings, boards, boots, mobile radio and GSM-locks, Barryvox, mobile phones, PDAs, laptops, beamers and all other lock able electronic devices (for kitchen, garden, garage)
Tracking-telling-soft Mare and LBS messaging for friends etc.
News, information, reports, manuals, ads of RFID-tags or other (Bluetooth) transceivers and over all in combination of transceivers with settings of filters according to ones interest, taste and time
Filter-functions for e.g. RFID/Bluetooth/W-LAN adds etc. (one ones head-set etc.)
Quick registration and blocking of RFID-, Bluetooth- etc. tags and of all Lock-Loop Internet-WAP-site registered products with RFID-tags.
Pupils, friends, family, doctor emergency-calls with key-setting-function for management of what kind of call- or action -recording or -registration
Foot-calves or mobile phones of pupils, students or for criminals, which are managed by the teachers, authorities or club-boss or family bosses
Vehicle tracking- or bicycle-, jam-, accident-precognition messaging
Clubs for the information of hidden radars or for similar other services
Receiving of all kind of (ads-) signals and automatic setting of television sets or other electronic transceivers, medias and sets on ones own personal preferences or of the other users.
In case of if in one room are multiple mobile phones set on one preference, so then will be chosen such information and news or broadcasts that is requested by the majority

### DECLARATION TO THE INNOVATIVE ACTIVITY AND TO THE NOVELTY OF THE AIORK PATENT

Because of our earlier filed Lock-Loop and because of this AIORK patent application we claim this intellectual property or a license of any other company or organisation, which is using, running or selling these new invented, developed, described and claimed applications and functions on a handset device.

As well with mobile phones and as well with gates such identifications can be made. I.e. e.g. only we decide and sell or licence the numbers of the RFID-Tags, which can be identified with mobile phones and gates.

Our identified and registered RFID-tag numbers will be offered for licensing exclusively to any interested fashion designer or sport or electronic equipment manufacturer company with this only world wide known becoming Lock-Loop standard and over all also Lock-Loop logo. I.e. a Lock-Loop dependent claim is that die RFID-tags are integrated directly in the brand and label logos or the cloth information. The Lock-Loop logo will be a “Must” for all noble-, high-quality- and -standard labels (e.g. Nike, Adidas, Esprit, CK or Sony, Philips, Nokia, Siemens, Mercedes, RR, Samsonite, etc.) . . . .

Only we are providing/running the only web-platform for the at least five different new applications (mobile phone and gate identification, registration, alarm, tracking, resale payment).

The AIORK invention is that with one single mobile phone the exclusive opening closing, locking identification tracking etc. of RFID-tags over “Near Field Communication” transceivers as well as over Bluetooth, W-LAN and GSM for all other new products as laptops, video-cameras and over all of radio (bicycle)-locks as well as for other vehicles or garages and doors can be managed. Every other company—over all every other mobile phone-(software)-manufacturer has to provide for each of these new application an other mobile phone, because without a AIORK license from us not two or more/multiple of these AIORK applications will be allowed to run on one mobile phone. Though nobody will like to carry around and have to buy more than one mobile phone for these applications. So only we can provide all these different applications simultaneously, coordinated and user-friendly on one mobile phone, software and web platform.

In case of if we will be able to claim also the feature or combination of “NFC-transceiver, biometric fingerprint-sensor identification, GSM-module and web-platform” over one mobile phone or over one extension kit, then we will have also the intellectual property claim for the best access-control and direct-payment applications as well as anyway with this All-In-One-Remote-Key patent it will be very difficult for any concurrence to launch any other interesting NFC applications, because the marketing of the marginal applications will be to expensive.

In case if there will be other direct tracking-applications-concurrences so they might be up to date www.verilocation.com, www.traceamobile.com for mobile phone tracking. These providers must not offer GSM-radio-locks as well as over the GSM-net self lock and unlock able mobile phone tracking or such products. This is why we have claimed in the “Lock-Loop” patent the central private policy claim with tracking for “self authorize able (opening and locking) radio-locks” as well as in this AIORK patent again the feature in description point 60:

WAP mobile phones could have been tracked for a long time by GSM- or GPS-net, but it was not feasible to lock them from misuse (by such a functioning locking order or call to the mobile phone), because up to date it was possible to switch them off entirely, but then the GSM-tracking was not possible any more.

With the AIORK-software it is possible to track, open and lock over GSM, Bluetooth or W-LAN a switched off mobile phone by other mobile phones as well as (principally here the same) GSM-radio-locks (GSM-devices). Anyway as for the radio-locks as well as for the mobile phones etc. we have claimed another additional private policy claim in our “Lock-Loop” patent for these GSM-devices (mobile phones and/or radio-locks), because convicted in the home penetration process or children must not be allowed to be tracked by such a GSM-lock over the net as well as over all must not open the locks without authorisation, so that this allowed us to claim the new innovative feature for these GSM-devices, because there existed never such a GSM-device before that, wherein one could give for unlocking of such GSM-devices ones own authorisation . . .

Our radio-locks as well as mobile phones with AIORK-software can be tracked as well as over GSM- and GPS-net as well as also now over Bluetooth equipped mobile phones and it is now possible to lock ones GSM-devices (mobile phones or radio-locks) (so that any unauthorized use is not possible) as well as to open/unlock (to make it work), though always the tracking over GPS- and GSM-net is feasible as well as now over all Bluetooth mobile phones, (wherein one also can track and manage ones GSM-devices the same as already over the GSM-nets). With the AIORK-software it is feasible for the first time to track also switched off mobile phones, radio-locks or electronic products, wherein the owner can switch off the AIORK-software only with his code or his authorisation and even only he can do the switching off of his mobile phone whilst always the GSM-, GPS-, Bluetooth or W-LAN tracking function is running. I.e. over these transceivers the tracking in spite of switched off GSM-device is feasible. The AIORK-software allows only to the owner to lock/open/track/use his mobile phone, PDA, laptop or radio-lock when he gave his biometric authorisation for it.

These differenceations and invented patent claims bring a huge advantage for any other mobile phone or anyway for our radio-lock tracking in contrast to e.g. “Verilocation”, “trace a mobile”. Mobile phone tracking as well as also these claims are double improved claimed in our “Lock-Loop” and this “AIORK” patent. —It is a pity that next to all our product tracking for RFID-tags, electronic products, beamers, video-cameras, laptops, radio-locks and mobile phones unfortunately no children or convicted tracking can be provided from us exclusively, because here our “Lock-Loop” patent was not any more new nor innovative, because it was new designed upon the existing children and esp. convicted tracking and now upon this as new genius AIORK patent claim for GSM-device with tracking-features has been found out and invented.

The reason for this lacking WAP-mobile phone tracking-service is that the mobile phone industry has (never had) no interest to make stolen mobile phones track able, because of course they earn more with so new necessarily rebought mobile phones. The same for laptops. It is good that we can now that's why also go into these GSM-product-tracking-applications and to be able to claim this intellectual property and not only to sell such products (GSM-devices) and also to claim fees for this LBS (location based service).

### DESCRIPTION OF THE DRAWINGS AND PICTURE

The innovation and the advantageous solutions are described here following with references to the schematic drawings and pictures. They show:
Drawing 1 A general presentation of the functions and applications of the AIORK-software on a list as they look on a display and on a device
Drawing 2 List of the most important transceivers, modules, functions and applications of the AIORK software- and hardware-solution
Drawing 3 Presentation of the function of the AIORK-theft-protection-safety-solution with Bluetooth modules in the radio-locks of vehicles

### DESCRIPTION

1. The “All In One Remote Key” (AIORK) is a mobile handset device with multiple transceivers (GSM, Bluetooth, NFC, W-LAN) and with a fingerprint-sensor (access, code, number, password, ID, authentification, authorization, buy/purchase, sale, payment, control of function) for direct assessment and access on a interactive Internet- or mobile-phone-platform (with video hit-lists or hit-charts, content, television-channel, game, service, product, software-implementation, authorisations, polls, rights and duties, partner-meeting, stock-, bet-, business and payment control features) in one mobile phone—or in one extension kit, in one software and in one list for opening, access, use (for among several keys, i.e. for a part-function (e.g. only vibra-alarm in movies, only SMS, filter-functions, adds etc.)), additional information, authorisation and tracking for one or several radio-locks (for bicycles, vehicles, homes) or keys simultaneously or not (i.e. for the whole garage or only for the vehicle etc.) and for mobile payments as well as for RFID-tag- and further applications.
for the transmission and authorization of a mobile phone key set on a mobile phone of another person!
for downloads of last newest AIORK key software (if this Bluetooth, NFC, W-LAN, IR etc. transmission could become decoded (chopped))
radio locks for (engine) bicycles, vehicles
radio house, garage and room doors or cinema, sport-starter, public traffic etc.
direct M-payment from mobile phone to mobile phone or MP3-Player, cashes, automat, air-locks.
radio air-locks with direct exchange account over Visa/Master-Card etc.
(NFC, Bluetooth, W-LAN, GSM, UMTS) RFID tags for bindings, board, boat, mobile GSM locks, barryvox, mobile phone, PDAs, laptop, beamers and all other lock, unlock able and adjustable electronic devices (for kitchen, garden, garages)
software of description of way, in order from point A to B to be guided.
message, information, reports, manuals, advertisement of RFID tags or other (Bluetooth) transmitters and over all in combinations of transmitters adjustable after desired filters (topic, taste)
filter functions e.g. with advertisement etc.
fast registration and blocking of RFID tags and of all LOCK LOOP Internet WAP site registered products with RFID tags.
pupil, friends, families, physician of emergency calls with key adjusting function for which kind of call or action, or admission, or registration.
foot chains or for mobile phones of pupil, students or culpable ones, who become of teacher or authority, club boss, or family head mobile phone steered, i.e. blocked etc.
vehicle following or bicycle driver, back-up, accident ahead notification of emergency system in and disconnection (with criminal ones) for bicycles or car or trucks or other LOCK LOOP of products.
clubs for information (report of radar traps or other services) or with cumulus maps
automatic control of televisions or other electronic devices
can be confirmed at cashes or with sales of registered products, with a simple function of the property changes mutually, because the owner has only the authorization to publish the names to the registered number.
   2. It has a detection function for persons and/or mobile phones and/or devices with Bluetooth or other transmitters in populated areas/areas or otherwise where and for the detection of mobile phones in avalanches etc. over a mobile phone to mobile phone net and/or to devices with Bluetooth or other transmitter, which radiate an identification number and which detection of all devices with a compass software in the mobile phones makes possible, which all identified numbers conveys to LOCK LOOP the Web platform or other one.
   3. The AIORK software managed signals of avalanche burying devices, docks, engines, or vehicle attitudes over NFC or Bluetooth etc.
   4. RFID tags cannot only identified by this AIORK mobile phone software, but also with an alphanumeric key code to be described and/or (secretly, protected) be locked.
   5. The AIORK software has (ect. for the administration of the RFID tags.) and the entrance to the only LOCK LOOP Web platform as also to several and/or all other Web Site.
   6. Information from RFID tags in dresses or Bluetooth products can be transmitted over the AIORK software to devices such as washing machines, TV, video Camera or recorder or engines or other (electronic) products.
   7. The AIORK software managed and conveys the numbers or the information from RFID tags or from BluetoOth transmitters, which are registered with criminal or violent Handling by the mobile phones.
   8. The AIORK software differentiates between Bluetooth, RFID NFC, W-LAN, IR, GSM and government inspection department signals and of signals of animals, humans, devices and can receive and send and transfer from a transmitter in the others.
   9. The AIORK software steers the helping and full duplex VALUE enhancement hardware, in order to identify RFID, Bluetooth or other transmitters.
   10. As with Bluetooth, W-LAN, IR, government inspection department or GSM there is to be a hard and v.a. also for the NFC RFID tags software, which like a compass the direction indicates acoustically or visually to the different multi-functional tags, whereby the software can a selection give or after completely determined tags (e.g. key federation in bags) to detections make can.
   11. The AIORK software is used also in/for door or all other radio locks with GSM solution (not only classical mobile phones) with Bluetooth or other transmitter modules conveyed, which over Bluetooth or the other transmitter modules a registration of all devices with transmitted ID to permit and the information or an alarm as with the air-locks over the LOCK LOOP Web platform.
   12. The AIORK software conveys all data of the RFID tags or the product number, like manufacturer series and the identifier or the identification equipment.
   13. The AIORK software identified, conveyed, steers managed all information from biometric or personal, physical, medical: physiological, psychological, physical data, which are conveyed by RFID tags or Bluetooth transmitter etc.
   14. The AIORK software again identifies biological and physiological data and values of our LOCK LOOP of radio locks or others over Bluetooth, RFID etc. radio conveyed data. Additionally all inventions DE10204028, DE10140968, DE10132759, DE10102564, DE10058157 and DE10058156 of described mobile phone characteristics announced by Vita phone are transferred also to our AIORK software and our GSM radio locks for bicycles. The Vitaphone mobile phone government inspection department solution also over our extension kit with the AIORK software to run with a finger-print sensor as emergency button for is awake, police, fire-brigade etc.
   15. The AIORK software managed directly or indirectly all LOCK LOOP transmissions on security. I.e. another so-called LOCK LOOP Web Site cannot be contacted by the AIORK software and/or in reverse exactly equivalent also,
   16. The AIORK software managed drones of electronic radio (bicycle)-locks, which do not have GOVERNMENT INSPECTION DEPARTMENT or GSM modules, but only (Bluetooth)-transmitters. A “Catch the Thief” function in the radio locks or the Bluetooth capable electronic products sends a signal over (Bluetooth)—the transmitters directly to each mobile phone into the proximity (such club Members with the AIORK software), so that this can stop the thief or the vandals or the police or the owner can alarm directly indirectly or unconsciously.
   17. The AIORK software identifies and locates barryfoxes with Bluetooth, GSM or GOVERNMENT INSPECTION DEPARTMENT or to other mobile phone compatible transmitters.
   18. The AIORK software completes the exchange with constant Web transmission over NFC or Bluetooth with gas stations, automats or other unmanned devices. Mobile phone must be held forwards and/or during and/or after the purchase of the fuel or the commodity at the gas station or the automat by the cashiers office or be in the Bluetooth reception range. The AIORK software conveyed thereby advertising information with these devices or with air-locks and takes up data storage of all made (trans-) actions and conveys it to an account. In the Gas stations, automats or other unmanned devices are not nothing else and a mobile phone or a extension kit integrated however only thereby opposite cashes by the salesman biometrically the authorization for the sales are actually thus confirmed.
   19. The AIORK software opens and does not only lock vehicle locks, but steers also directly the opening and bolting device of the individual doors and other functions like the opening and bolting device of the movement function of shock absorber, hoods, convertible covering via the mobile phone keyboard. 1 is activation on the left of door or wheel shock absorber etc., 2 is hood 5 in front is convertible covering, 0 is rear flap.
   20. In the AIORK software and/or the display and/or the mobile phone as on the radio locks and the RFID-tag a same AIORK and LOCK LOOP logo is evident.
   21. The AIORK software makes over NFC the fast data communication for their products, applications and solutions possible described by the mobile phone numbers and all Authorizations or other information the AIORK or LOCK LOOP patent application. A NFC fast function made possible according to the general slow Bluetooth function direct opening/locking or data conveying over NFC through into close proximity bring the mobile phones with the radio locks or the other NFC or Bluetooth to capable Products. With a biometric finger-print sensor the authorization is given.
   21. The AIORK software makes the direct paying of the bus, course, airplane, ski elevator tickets and shop for cashes possible by means of NFC, Bluetooth or GSM, UMTS transmission. The price becomes forwards, while and/or after the travel, service: purchase paid or can are changed. Each transaction will transfer Web platform directly to the LOCK LOOP.
   22. The AIORK software in the mobile phone is firm to a lock or at or in a part of the body fastened unit (clock) in contact and can implement only together in Bluetooth, IR, W-LAN radio contact with all this these remuneration functions or if one enters a code or with a biometric signal (finger-print, speech recognition etc.) the authorization will be conveyed.
   23, Physiological, technical (bicycle) data are possibly seized by the mobile phone over Bluetooth of the clock or (medical sensor) a unit by conveyance and passed on the LOCK LOOP Site and to physicians. At these units can be integrated emergency buttons, handless talking systems or other electronic technical solutions.
   24. The AIORK software makes and manages an electronic cash system (ECS). Mobile phone owners can give themselves mutually money or let or directly from mobile phone to mobile phone over NFC of money book let check-out counters and over the AIORK software about the LOCK LOOP Web platform or a bank register with or without bank or LOCK LOOP registration. On a display the current and past current payments and fees one holds.
   25. With a biometric authorization over acoustic speaking or visually face, iris or sensory finger-printer identification an ECS transaction is verified. The ECS blocks itself, if more than one, two, three . . . NFC readers are present recognized and or certain. In addition, AIORK software the ECS uses the Bluetooth net or the GSM net with same functions and principles! With the purchase of the AIORK software one keeps accordingly many Bon Robel money equivalents or genuine money on the LOCK LOOP platform credited, where each ECS transaction is conveyed directly.
   26. 1% of the transactions are charged to the LOCK LOOP Web platform as payment! On the LOCK LOOP platform or directly on the AIORK software can be installation-paid and exchanged further of Bon Robel money equivalents or genuine money and be further on transferred to further web-sites over the AIORK software.
   27. The AIORK software regulates also several RFID readers of identification systems to the identification of different IC from closer, further distance or with different information on different technologies or different coding or accesses with gates with or without spider.
   28. Over the AIORK software in particular function controlling of different electronic and mechanical or biological products, devices etc. become managed with Bluetooth, W-Lan and NFC.
   29. The AIORK software made it possible to note and convey directly also with telephone calls or with scene confirmations a snapshot of the surrounding RFID tags over a certain time interval as proof additionally to and with photography or also to telephone call, With the telephone listener an appropriate signal is conveyed, so that it gets knowledge from this action.
   30. Over the AIORK software a radio lock can be identified, communicated, and/or each mobile phone and each humans and/or each product can be registered. If a harmful human with its mobile phone come into the proximity of another, sent for defines adjustable distance radiuses of alerts and/or conveyed to the mobile phone. The AIORK software regulates this data security radius and charges regarding registered offences automatic penalties or sends alarms out to the endangered one, at people and at law and police.
   31. If a person with a stolen product comes itself or still better with a pistol into the proximity of protected (personality, office, law or military zones), safety stages are raised and alarms accordingly are sent. If a criminal person with pistol and in riot is registered, then a combination is calculated and with increased safety stages, more urgent and more important alarm priorities raised and transferred to other AIORK software mobile phones.
   32. Only “Bluejacking” do not know the AIORK software mobile phone, but also RFID and GSM jacking and evenly at the same time the jocking, which a reversal of the attractions alarms in escape and danger alarms are due to the most diverse above mentioned raised personal, strange, social and social environment safety and preference and/or priority levels and directly to the Head set or biomechanical, physiological peripheral devices and to other people, societies, institutions to convey.
   33. Over the AIORK software clarifications of products become possible like e.g. safety devices, lamps, engine data with and without RFID tags or Bluetooth and/or other 125 KHz frequencies. It managed biometric data acquisitions for Smart maps for physician, medicine, physiology, passport or stock exchange information.
   34. With a mobile phone those can seize of combined receivers/transmitter LOCK LOOP or RFID day chip, locates, to tracken and work on. This goes over several receivers/transceiver-systems (W-LAN, GSM, UHF, Bluetooth etc.). Biometrically or over other authorisations the bolting devices or authorisations for the LOCK LOOP chip or the RFID tags can be given/led by mobile phones or Internet (platform).
   36. A RFID Transceiver with biometric (finger-print, speech recognition and iris) sensor and other components can be attached also than extension kits additionally to a mobile phone over an external plug, Bluetooth or a exchange accumulator sentence. The kit knows also different functions and components such as AIORK software, mobile phone Software, mechanic and electronic key and pin with writing recognition, accumulator, memory, processor, government inspection department, GSM, UMTS, radio, camera, lamp, Game, screen, keyboard, headphone, high speakers, sirens, Bluetooth, “Legic”-chip, Mifare 125 KHz, Barryfox, IR (remote maintenance)-transmitters possesses separated or together e.g. than Head set to be separated or together from wrist-watch with physiological sensors and mobile phone be operated. Each mobile phone/PDA/Laptop or RFID reader with or without the AIORK software with a NFC or other 13,56 MHz, Bluetooth transceiver and USB plug is equipped or with such a extension kit connected, which with biometric sensor a function, finger-print is equipped how e.g., so that over short distances LOCK LOOP applications become possible like e.g. payment functions under two or several parties or access control functions and these transactions directly over GSM and UMTS our LOCK LOOP Web platform transferred, is completed and registered! The transceiver kit can be attached directly (over USB/Bluetooth) to Internet over a PC without GSM transmission.
   36. The AIORK software is a multi-functional sending, receipt and detection system and a multi-functional detection system, which transmitter for GSM and UMTS and whale Al valley Al and full elite possess transmission. It is possible for receipt of TV and radio signals, own body data (blood pressure, heart frequency temperature) that, government inspection department (with stick able outdoor aerial) and a mine and a coin and an avalanche pouring duck signal as detecting device.
   37. Into the AIORK software becomes also the guidance, which integrates management of the “Tbay” transportation and riding along (demand offer auction) internet WAP platform.
   40. The AIORK software managed WAP mobile phones with additive extension kits, which radio locks or open and lock/can switch off and with Bluetooth, and NFC and a biometric fingerprint or camera sensor or a speech recognition software are equipped, those with GSM, Bluetooth, NFC and infrared Transceiver in one both new RFID tags, and information-transceiver (e.g. with gates) and radio keys, which with Bluetooth garage doors functioned of course, but without Internet, geschweige then GSM connection and alarm transmission or direct management (open, lock, authorize, selectionize).
   41. The AIORK software managed motile phones or -auxiliary kits, which RFID tags or other NFC Transceiver with NFC Transceiver select. in particular with biometric authentification sensor and is directly coupled over a cable also to it fastened and/or connected key (federation) or central locking for car etc.! If a car with/without NFC etc. (over Bluetooth) is opened, there is a SMS of the car radio lock to the mobile phone of the owner. I.e. the AIORK software is dispatched over Bluetooth an alpha biometric code and over NFC beta biometric and/or sequentially itself minutely changing AIORK account code, after (alpha) the AIORK software in the mobile phone received signal from the radio lock a GSM (/Bluetooth).
   42. The AIORK software makes the identification with or without biometric mobile phone sensor possible RFID tags with money, animals or humans also for physiological, biological, medical values of implanted devices. With these RFID tags further functions become possible like e.g. with the money a counting or postings. I.e. within one area timelimit all tags are counted or taken up even with a correct photo over the camera and all Bluetooth, W-LAN etc. transmitter.
   43. The mobile telephone or -extension kit can be accepted also only by a reader and/or a day, if a certain personal authorization with e.g. is present over finger-print/speech-recognition and the okay of a data base. So only then addresses and money over NFC etc; may be conveyed or be accepted purchases/to sales with biometric personal authorization.
   44. With the biometric mobile telephone or -extension kit authorization may be also only implemented “Bluejacking” computer, auto, studio, home, advertising, payment, admission, beverage, meal and drug automats, medical physiology and worth living of collection device, door opening and television/radio “attitudes” and/or and the NFC/Bluetooth/Infrared mobile phone or -extension kit in the proximity or in contact with the other one opposite is direct.
   45. If identified numbers (RFID Bluetooth W-LAN) are not registered identified, the product is announced with this number as stolen. Products without AIORK or LOCK LOOP permission are discriminated against.
   46. The AIORK software managed when starting or beginning each mobile phone or video camera activity of the equipment its identification number out over Bluetooth or another transmitted frequency, which received from mobile phones with a AIORK software is administered and! The AIORK software managed the receiving of all possible (advertising) signals and automatic attitude of televisions or other electronic transmitters and devices on the adjusted preferences (applications, light, air conditioning, advertisement, music) users and transmission to the Head set.
   47. Over NFC can be certified with the AIORK software and/or with/without biometric sensor documents, examining hurry and/or control posts with RFID tags for vehicles, airplane or all different examining hurry, thief goods or test parts which can be certified.
   48. For insurance the LOCK LOOP web platform and the AIORK software is an ideal possibility to transfer insurance swindlers. To (e.g. bicycle) theft the properties must be announced within by three minutes to the LOCK LOOP web site. With recovery of properties confirmed with the mobile phone or even with a biometric authorization, whereby the payment of our detection is deducted and otherwise continues to run and further tracking is charged.
   49. RFID tags and Bluetooth, W-LAN and/or other transmitter signals can have special secret numbers and/or these to the AIORK software not convey or over them (coded) represent or a special biometric or other authorization of the AIORK software or also from a list in an Internet data base require, so that the AIORK software admits the number of the daily gives, represents or further administer lets!
   50. The AIORK software knows transceiver (for vehicles, packages, products, penalties, bets, taxes, NDA, enamel) with certain RFID tags or NFC or Bluetooth and other of these a security code to select or require, which only by authorized persons (law and police) to be identified to be able or to further identification entitled, whereby also for this on the LOCK LOOP web platform happens before the authentification/registration or is required.
   51. As the further advantage and/or to a further market gap leaves itself with the attachment of a little (ABUS) lock at the eyes a perfect mechanical theft protection achieved (e.g. nobody can enter any more into our snowboard binding or can unscrew it from the board). This principle of the mechanical theft protection is integrated naturally also in the LOCK LOOP patent and will be managed by the AIORK software. I.e. on each (visible) unit and each RFID day lockable with a lock large “LOCK LOOP” is visible imprinted and evenly a RFID chip inserted a “Registrations and/or a license number” for every body. Thus are so be dammed with the lock around the RFID day theft and illegal Eastern Bloc or Asia copies and/or -imitations, because only our products an insurance protection guaranteed legally. The number permits however also the finding and the management over the mobile phones with the “AIORK” software.
   52. Over the AIORK software with or without biometric finger-print speech recognition or other sensors in mobile phones or associated extension kit with bank teller machines, parking meters, automats, bars for beverages and v.a. with cashes and air-locks or entrance doors over NFC, and/or successively Bluetooth or other transmitter technology an ACCESS control and v.a. Direct Payment functions are at the same time completed. Forwards and/or during (that is ongoing or with interruptions) and/or at the conclusion of the consummation must be kept and/or terminated to biometric authorization by the consummation activated and/or upright, whereby the consummation is booked directly/sequentially later over GSM/GPRS/UMTS/W LAN by the mobile phone on the LOCK LOOP Web portal. The AIORK software can be stopped in such a way that most diverse possibilities of the safe deductions and their controls can be stopped is only over Bluetooth or with NFC and biometric authorization connected deductions. Can be determined also over Bluetooth the park range or other motion travel and/or periods and the user can over NFC of ranges and areas over or without a biometric (finger-print) sensor deduct or book or refuse and define, I.e. e.g. in a parking garage/house the car or the driver pays less on an apron or—, as if it leaves it.
   53. The AIORK software managed exchange like evenly the Direct Payment or the currency exchange with genuine or with play money over biometric finger-print, speech recognition or other sensors in mobile phones or associated extension kits will run with banks, institutes for payment, stock exchanges, auctions, lotteries, bet and gaming houses, legal institutions directly locally over NFC, Bluetooth or another transmitter technology and/or over encrypted email or SMS traffic over the AIORK software and/or are. ACCESS control with more biometrically visual (iris, several eyes, face (it)) Identification, where within a certain time or at the same time mobile phone or -extension kits with NFC to another mobile phone or extension kits or radio lap or a cash, air-lock are held to the opening bolting device/authorization with a Okay Button or otherwise acoustically, visually gemanaged will and where in addition also over Bluetooth, GSM or other transmitter Technologies this becomes gemanaged. During or not during telephoning the simple smart management of the radio locks is to be ensured.
   54. The AIORK software managed with Direct Payment and ACCESS control over NFC, GSM or Bluetooth etc. that only or a certain number of further counter receivers and/or -transceiver in the mobile phones, cashes, doors, air-locks a transaction or a deduction run and/or are certified. I.e. criminal espionage with transactions and deductions will be so avoided, and the two parties its authorization and deduction will be proven anyway and to confirm must forwards, during and after the transaction.
   55. By the AIORK software emergency calls are to become public or private institutions with e.g. accurate government inspection department detection and direct person identification over an emergency button with biometric finger-print and speech recognition sensor in the mobile phone or an extension kit.
   56. In the AIORK software profiles can be entered and stopped over person, occupation, preferences, inclinations that as with “Bluejacking” over NFC, WLAN, IR between the mobile phones are exchanged and over Bluetooth with our new radio locks and with gates, attitudes and data in particular over attitudes and data entered of physicians, authorities, garages, specialists.
   57. For mobile phones or all other PDAs etc. the numbers on a Internet site can to be e.g. will be managed as downloaded for a “Friend Finder Function” on the mobile phones, PDAs, laptops or vehicles, The “Friend Finder function” is over Bluetooth, NFC, W-LAN, IR, GSM etc. of running direction manager like a compass to friends or products with RFID tags or other products with e.g. Bluetooth, GSM, W-LAN, IR etc. transmitters, which registered a number on our ‘LOCK LOOP ’ Web platform in the environment or at certain places, which the localisation of the friends/enemies/all products and other tags or microchips, transmitter like e.g. television stations or -channels or RFID tags permits! Of course can be tracked so also the RFID tags or electronic products with the numbers! Everything will be found, and to be individually locked! An auxiliary function permits it in and over several radio interfaces and/or mobile phones away that thereby on defined distances each RFID day or electronic products will be tracked, The detection over a Bluetooth or other transmitters net, from government inspection department mobile phone to mobile phone would be the finest best detection of Bluetooth, NFC, W-LAN, IR etc. capable stolen motile phone, PDAs, laptop, video Cameras etc. and Bike LOCK or Barry Fox, because the GSM cells detection is too inaccurate. Anyway it needs to locate a compass function for avalanche-buried, going into the same direction, with mobile phone or Barry Fox or friends and/or its Bluetooth capable laptop, PDAs, laptop, to find video cameras. In the mobile phones it has software for fine direction management over Bluetooth or another transmitted frequency. Who wants not to let its laptop or its video Camera etc. locate, this must with a special secret, only with the delivery packing or the manual shipped code to deactivate and/or activate, in order to let its property make detection able, This code is deposited also with the registration at the LOCK LOOP Web Site together with the serial number of the registered product. Apart from vehicle and persons and/or mobile phone detections the new radio locks, and all electronic devices are or other products new place and register able owners, who are offered with one and/or on only one platform. One does not want to become customer of three (vehicle, Bluetooth or RFID products) different detection services which can be paid. The “Friend Finder function” is started and accounted for pulsating in time intervals.
   58. The extension kits with NFC Transceiver have a CCU, a memory a plug for a USB memory, solar panel, a government inspection department receiver a biometric (finger-print, iris, face identification sensor, microphone, loudspeaker, digital display, clock, one RFID day, a key, a measurer, a screwdriver, a USB connection, a clock, a Bluetooth transmitter and a GSM module.
   59. The AIORK software managed multi-compatible NFC and 125 kHz IC. I.e. not only the identification of 13,56 MHz IC but also in particular those the double or repeated IC with 125 kHz or 2,4 (5) GHz also and the same or different number become of the AIORK software and together with the “LOCK LOOP” Web platform gemanaged (numbers to administer, register etc.)
   60. WAP mobile phones could be always located by GSM or government inspection department net, but it was not possible to lock them (to send such an instruction at mobile phone, but if to then turn off only completely, wherein however the GSM detection is no longer possible), With the AIORK software it is possible over GSM to locate and open Bluetooth or W-LAN switched off mobile phone nevertheless still over other mobile phones and evenly (here same in principle) GSM radio locks again/unlocks. Anyway we have here for the radio lock still another additional requirement for data security in the LOCK LOOP patent that and condemned in the home meeting execution or children with GSM lock not over the nets to be tracked ran not the locks to open not be allowed/be able without authorization. Our radio locks like also mobile phones with AIORK software can be located in such a way both over Bluetooth but now also over GSM and government inspection department net and it are here possible, which unlock mobile phones or radio locks to lock to make functioning (for the strange use) and again to open/(makes functional), whereby the Tracking is possible over GOVERNMENT INSPECTION DEPARTMENT and GSM nets always and in particular also now over Bluetooth mobile phones, where one can also be managed equal mobile phones as over the GSM nets in such a way. With the AIORK software it is the first time possible motile phone also turned off which can be had, radio locks, to tracken or electronic products, whereby the owner can switch the AIORK software off only with his code and/or his authorization and makes a turning possible of a mobile phone off permitted and the GSM, GOVERNMENT INSPECTION DEPARTMENT Bluetooth or W-LAN detection possibility are adjusted otherwise always, i.e. these transmitters for the detections despite turned off mobile phone are still possible.
   61. Expenses accounts of Direct Payment and ACCESS control are completed and/or deducted on the AIORK software directly on the tax declaration (software) and cleared over a direct GSM transaction on the LOCK LOOP Web platform. This service is offered to patient map accounts or post office accounts, value added tax etc. also for medical insurance—and in special and unlocked with biometric authorization and conveyed always directly on the LOCK LOOP Web platform. For the tax form the seasonal process of the place of residence is held like also all other tax legal activities and placed to the deduction with software to the order.
   62. The AIORK software points to activates/calls in the mobile phone display telephone numbers for alarm, info. Or hotline calls of products with RFID tags or other Bluetooth etc. information.
   63. The AIORK software managed the school hour plans and announces parents like also the school, where the children/pupil are. The AIORK software supplies the whole time table, which is placed from the school to the order in a Package also and conveys alarms and information for the teacher, school line, schoolmate and parents.
   64. The AIORK software looks for certain RFID tags and traces of it in the nets over all possible mobile phones and air-locks over NFC, Bluetooth, W-LAN and naturally GSM etc.
   65. The AIORK software supports the mobile phones or extension kits with biometric (finger-print etc.) sensors by integrated PGP or Omar's an email or also telephone call and/or acoustic Dictaphone language recording coding. With each restart of the mobile phone a biometric identification is required. With each email a payment and a biometric authorization are booked, so that spam will be complicated expensively, secondary complex.
   66. At the extension kit as at a mobile phone it has to open one, locks or always closed eye for me electric circuit and sequential RFID day in it for the mechanical attachment of these two parts and for the attachment of keys etc.
   67. With a simple all surrounding doors or radio locks with authorization press are opened and all possible payment possibilities on the display offered at the same time on the finger-print sensor, so that bus and Bancomat parking meter over Bluetooth/NFC and Direct Payment over NFC/Bluetooth can be deducted.
   68. It AIORK software is connected to and with (e.g. SAP) firm management software and, so that their co-worker, team, projects and customers become direct with/of the AIORK data over place of residence (over government inspection department, GSM), time etc. gemanaged (to be able) and which is confirmed with Biometrie.
   69. The AIORK software conveys alerts and indicates the places, from mobile GSM radio fire alarms safety devices (—boxes) or electrical, water, gas meters, which have a defect.
   70. The AIORK software managed the account for customers of “call A Bike” or other renting vehicle or—RFID day or other electronic renting products, like video Cameras etc. with all direct accounts for taxes etc.
   71. The AIORK software in the extension kit or mobile phone looks for automatically over Bluetooth mobile phone or extension kit, so that the access and over all direct M-payment functions will transfer control directly over GSM etc. to the LOCK LOOP web platform. Each transaction is announced by GSM also on mobile phone of the owner.
   72. The AIORK software in the extension kit or mobile phone takes up automatically each discussion or picture (constantly) and each W-LAN, Bluetooth, NFC radio and can with the biometric finger-print as coded email be dispatched and archived. Thus plant fraud will be much harder other misunderstandings avoided or at least reduced. Slips, Business documents, forms for authority can be conveyed in such a way and be secret directly biometric with the sensor in the extension kit as or sealed confidential.
   73. The AIORK software managed with place and RFID number all products of old Ricardo and Ebay etc. auctions, those were not auctioneered or from old sales resounding and residual item camps, which can be offered again and even with LBS functions shipped.
   74. A NFC, a GOVERNMENT INSPECTION DEPARTMENT, a Bluetooth Transceiver (module) alone or with a Biometrie sensor etc. like a plug-in card into the extension kit can be or into mobile phone. The extension kit has multiple USB plug and all other plugs for the usual mobile phone models.
   75. With the biometric finger-print sensor over the extension kit or mobile phone or PDA, laptop over Bluetooth one can log in directly with Internet bank accounts or with stock-exchange places, or lotteries, bet and gaming houses and also for purchases/sales/trades the authorization or confirmation of the transaction over the finger-print sensor deliver.
   76. Telephone calls or picture telephone calls become over the biometric one (finger-print)-sensor authorized, so that the calling is safe, to have also the correct caller at the telephone.
   77. Among friends LBS attitudes can be made for Meetings that a signal is transmitted that to meeting is distant from the other one still 1 km etc. or 1 minute for the etc.
   78. With the AIORK software with the finger-print sensor a photo is indicated to the person on the display its and/or the other one its mobile phone evidently and/or over NFC. Bluetooth transceiver the testers, policeman, security people. That is an electronic passport or document of identification under humans that with Events only mobile phone and owners receive authorized ACCESS. These data can be used immediately for competitions, Mailings etc., whereby the owner can adjust itself these releases in the AIORK software.
   79. An extension kit can be attached not only to mobile phones, but also to beverage, coffee, nutrition, cigarette, gas station, or parking automats or cashes and beside GSM, NFC evenly also government inspection departments possess, with which always also place and time can be indicated by a money transaction.
   80. The AIORK software makes possible to hold the park time and place over government inspection department on it and each police man can over its mobile phone on the LOCK LOOP Web platform check whether for the vehicle the fee was paid!
   81. The AIORK software makes possible to lead tunings across mobile phone and/or extension kits with biometric finger-print sensor or another biometric sensor. Forms for patents, tax declarations or other forms for office or internally confidential or secret documents can be conveyed by Email/SMS secured in the office, on the office sealed.
   82. The AIORK software makes possible to lead mobile phone and/or extension kit across the exact LBS across government inspection department and to send with an emergency button of alarms to police, coast or mountain guard, outpatient clinic, psychiatry, helping hand, alcohol and drug approach places, toxicological institute, fire-, oil- and chemical security.
   83. The AIORK software makes Internet and GSM the UMTS net with a Direct Payment or an ACCESS control transaction always also at the same time or at least temporally retards a confirmation of the transaction over on the LOCK LOOP Web platform!
   84. The AIORK software over mobile phones or directly over the extension kit can be connected by laptops and PDA's also with the Internet. The extension kit or mobile phone with AIORK software finger-print or other biometric sensor, NFC, W-Lan and Bluetooth etc. laptop, PDA mobile phone can be connected mechanically or also electronically and be still possessed the same functions as a computer mouse, remote maintenance etc. with USB plug and all different one for the different mobile phone and PDA of models with computer.
   85. The AIORK software managed post office and payment into the bank lights, punishing excerpts, penalties and personal records, because all transactions with biometric sensors and proofs are managed, authorized and/or registered and transferred to the LOCK LOOP Web platform. Over the AIORK software can lotteries, play and stock exchange transactions with the finger-print sensor secure to be authorized.
   86. The AIORK software gives with each email, to SMS etc. of which with a biometric sensor will be identified and get an official proof like a written letter that the email was sent.
   87. The extension kit with Bluetooth is the only extension kit, which can be put additionally at mobile phones without Bluetooth and which may send to Bluetooth head sets or other Bluetooth devices. The same as with Bluetooth transmitters concerns also different transmitters as W-Lan, government inspection department, NFC.
   88. The extension kit is fastened beside the Bluetooth and USB etc. patch cord binding with a connection catch to mobile phone.
   89. The extension kit has additional memory cards or additional interfaces and Slots for memory cards and -chips.
   90. The AIORK software starts the engine of car, motorcycle, ships, airplanes or other with keys products which can be started such as saws, air conditioning, laptop, pumps.
   91. The AIORK software can be stopped in such a way that it starts an alert, if a Bluetooth transmitter in its purse or in its suit-case, bag etc. from the Bluetooth etc. radio range disappears, The same with the extension kit or the mobile phone more. The Bluetooth transmitter is packed into credit cards a large housing, where it is turned off also on and a battery has solar panel, finger-print sensor, digital display, Jog dial or even a lock and a cable and a RFID day! The Bluetooth transmitter can be even directly in wallets and suit cases, bags trained.
   92. The AIORK software permits it each mobile phone or extension to kits with payment function and a credit on the memory to tracken over government inspection department, GSM and over Bluetooth, W-LAN etc. whereby an acoustic like also visual warning signal is sent.
   93. The AIORK software permits it, each mobile phone or extension to kits over Bluetooth or W-LAN with an emergency call signal at police outpatient clinic, rescue ect., ate if no government inspection department in the mobile phone or extension kit is that with every other mobile phone or extension kit or radio lock in the radio range the accurate government inspection department detection is made:
   94. The AIORK software has at the sane time also on the LOCK LOOP bank account an algorithm for a AIORK security code to run, which changes as with Secured Direct Net maps sequentially every few minutes, so that only with this AIORK code and the personal finger-print code at this time (in this minute) a transaction with the AIORK over NFC/Bluetooth/W LAN etc. can be made. The AIORK code can again be constantly downloaded again with a pin by the LOCK LOOP platform and be installed for a certain time on another AIORK mobile phone, so that thereby Direct Payment and ACCESS control applications can be transacted. The pin consists of an AIORK mobile phone numeric part and a finger-print part of the owner also which can be entered. The AIORK security code can be sent either sequentially daily again to the mobile phone or can be requested in such a way or must only once be installed or sequentially on mobile phone and/or with completely normal telephone calls over mobile phone is sent! If necessary, still another password can be required for transaction. Each transaction is registered thereby (optionally) directly by SMS at the AIORK mobile phone owner, so that it is informed always about all its bank transactions and can if necessary act, if somebody else lets a Transaction run over its LOCK LOOP bank account. This concept can be applied also to the ACCESS control, RFID day and v.a. the radio lock opening and bolting device solutions. For smaller amounts at automats actually already meet an adjustable daily, evening or 4 h limit of 100 SFr., 50 SFr. or 20 SFr., without additionally a GSM call must be made the inquiry (AIORK) of the security codes for higher amounts . . . . Rut anyway with each telephone call can/automatically also (AIORK) the security code and the personal finger-print or the own personal language sample code will be clarified.
   95. for post office dispatch packages a biometric authorization over mobile phone is made, where the delivery of the package with RFID day stamp is transacted or -adhesives from person to person with direct GSM transmission to the insurance/bank/sender/owner. Wherein they are conveyed to code transmission with the delivery additionally for the AIORK security code of pictures of the faces (made and) (each other shown) with a second finger-print authorization and/or-. With mail box packages can be also thrown in such a way, whereby the mail boxes also an extension kits with NFC/Bluetooth and GSM module, so that the delivery is confirmed, In the package is thereby a Bluetooth/NFC/WLan extension kit. With a delivery a photo can be made by the taking/product/receivers. This concept can be used also for borrowing from products, where beside the photo of the place and product, RFID day identification is made by the product, the finger-print sensor identification of the person.
   96. The AIORK software can be supplemented like Linux by user as open Platform, where the new solutions and applications can be downloaded over the LOCK LOOP platform.
   97. Over the AIORK software each mobile telephone call can be stopped in such a way by the mobile phone owner that these only with a biometric authorisation will be made to be able.
   98. The AIORK software can head for by Bluetooth (hid) (in a radio lock) and, those in vehicles the central locking served and/or with it connected is or with houses, garages the doors in such a way open and lock can other radio of based devices served for air conditioning, television etc.
   99. The AIORK software managed the SMS reminders of creditor, if these want to communicate their customer the strikes by SMS, so that no reminding or distortion damage expenses develops and the calculations can be paid. With a finger-print the confirmation sent back that the report over the strikes were noticed, and will be directly covered (to be able) over such AIORK Direct Payment!
   100. If with a mobile phone or a extension kit with AIORK software a wrong pin or a not authorized finger is pressed on the finger-pint sensor around an ACCESS control or Direct Payment or opening function to start, an Bluetooth alarm to other Bluetooth devices with GSM or directly an GSM alarm sent.
   101. At a direct Payment or other AIORK software function and/or application completion the content by the AIORK software in the mobile phone or extension kit buffered and only with later GSM speech recognition passed on the LOCK LOOP platform and/or an account.
   102. Auction, payment, and stock exchange authorisations can be transacted over the finger-print sensor and/or a pin over AIORK software in the mobile phone or extension kit.
   103. If a new AIORK software component is loaded and implemented on mobile phone, PDA, extension kit, the IMEI serial number is being checked and tracked during previous loss message on the LOCK LOOP Web platform the equipment.
   104. Over the AIORK software a finger-print sensor a coded Bluetooth or another signal can be sent to the central engine control unit by vehicles over, where the engine thereby is started. The central engine control unit has transmitter also still another GSM module beside the Bluetooth for the detection and alarm transmission, if the car, which will be a stolen unit, and a movement sensor or other devices the theft or bad starting to register and announce on mobile phone or the police like that as it in the LOCK LOOP the patent for this mobile telephone platform is described.
   105. The AIORK software with Bluetooth, NFC and FP-sensor etc. managed beside mobile phones and extension kit also in and to wrist-watches or MP3 or other music Players with radio or TV-channels with appropriate tuner and video hit lists, which are loaded over GSM and in particular over UMTS nets down, The audio signals are conveyed on the Head set and the video signals on a monitor on a mobile phone or a PDA.
   106. The AIORK software can be de-energised only over a provable code transmission and/or decoding on the LOCK LOOP web platform, so that the extension kit or mobile phone only these persons authorized of can be ended, In particular for the “Direct Payment” payment application needs it a double pin and finger-print as code for the bank account opening to the shop of the money account memory over the AIORK software.
   107. Each “Direct Payment” payment is registered with the AIORK software from the owner to the buyer with data over price, place, date, mark, number of items, supplier as with cashes and deducted for tax declaration etc. A credit can to be become as also a payment buffered in the memory of the AIORK software, until in the evening on a docking station over Internet or over a GSM binding the deduction with finger-print sensor and pin code is authorized.
   108. The AIORK software managed all personal attitudes of persons/individuals over preferences (music, channel, air conditioning, seat position), physiological biological body and disease data or the software and/or system data for e.g. the attitude of the radio for “Traffic” functions, thus the appropriate local, spatial and terms and in vehicles of private and public means of transport to be adjusted over Bluetooth/Wlan/NFC.
   109. With the AIORK software know all kinds of devices such as clocks, key federation or purse, mobile phone, PDA, extension kit and radio locks over the Bluetooth or NFC transmitter over short 10-100 m distance located and managed become . . .
   110. The AIORK software has a software additive, to make which makes it possible in EK, PDA, mobile phone, from whose GSM modules a distance computation the GSM or UMTS masts. New antennas are also recognized thereby and the Coordinates is taken into our mast maps and/or transferred directly.
   111. The AIORK software and/or a extension kit with Bluetooth and NFC transmitters and finger-print sensor a mouse can be and v.a. a key board or another acoustic, visual input medium attached and/or integrated and in particular with movement sensor as a LOCK LOOP GSM radio lock in Bankomaten, parking meters, automats, cashes or other valuable properties also to or into a modem!
   112. The AIORK software and/or a extension kit with NFC, Bluetooth and FP-sensor opens not only radio locks with bicycles, vehicles or doors, but unlocked/unlocked also for radios, engines, computers, PDAs, bank teller machines, cashes, documents of identification, TV-info, and advertising devices.
   113. During the first RFID day identification must be paid a license or be entered on the LOCK LOOP Web platform a license number for the extension kit.
   114. With each transaction or when switching on and off is sent a Bluetooth, to NFC, W-Lan pin code that this equipment straight at this place is, and over each extension kit in mobile phones, or at cashes, parking meters to LOCK LOOP transferred the Web platform and/or from there to the mobile phone or email account of owner, if it announced it stolen.
   115. If one comes into the proximity of extension kit or at automats, cashes, Bankomaten, parking meters or mobile phones, a Bluejacking advertising or info. Message is conveyed, which can be adjusted to personal preferences.
   116. For the Direct Payment solution is loaded daily with the docking at its own computer and Internet connection a new coding on the AIORK software, whereby also again with a finger-print biometrically one authenticated, so that only this code combination is not accepted and all other past no more. The same with each telephone call over the GSM net.
   117. The EK for at clocks is fastened by means of the bracelet under the clock, whereby the volumes are led by two slots.
   118. A control for over IrDA TV-devices etc. has to head for the EK and/or the AIORK software.
   119. The AIORK software can load other RFID tags and/or NFC trailers with credits, in addition, unload and/or can only with an authorization of the RFID day and/or the NFC trailer, if e.g. the owner knows the pin code from the day.
   120. The AIORK software has additional better coding solutions, which already inserted an additional local and temporal independence/obstacle which does not represent for clever thieves also a hurdle more, because if they hang small espionage transmitters to the Chassi when starting, driving and when turning the car off, this because of NFC sufficient far send can, in order to spy the coding code.
   121. The AIORK software has digital camera a connection and/or an extension kit can also such a camera possess.
   122. In such a way the EK with AIORK software can pick RFID tags out with larger transponders achievement (boost) over larger distances, so that e.g. detectives or personnel can make identifications still on the road, whereby directly over Bluetooth/GSM of the cash the all regularly sold and/or the not sold products are conveyed on the AIORK software.
   73b. The AIORK software can for old auctions for products with/without RFID tags the offers/requirements store and with later interest in the sales/purchase the bidders a report makes whether still the interests made with biometric fingerprint sensors are valid, so that nevertheless still another contract comes to conditions.
   123. The EK with AIORK software can read and describe RFID tags or other active transponders both over 125 kHz or also over 13,56 MHz (Mifare) or still different frequencies and technologies such as Bluetooth, W-Lan etc. and/or communicate in such a way. An acquisition made with the AIORK software is registered on the LOCK LOOP Web platform.
   124. The AIORK software recognizes a money acoustically specified beside a manually entered also over the Headset or the extension kit or mobile phone and indicates it directly with finger-print sensor contact on the own equipment and on that facing equipment, so that there with finger-print sensor contact immediately also the transaction is deducted authorized. A simple double or repeated sensor contact can mean or up and/or down up a driving on a slide sensor a purchase or a sales.
   125. The AIORK software permits currency-independent and/or paying possible without rate of exchange losses, as simply a new M-Payment currency is introduced, which no on and selling rate difference (EN) has and with all currencies to their current on or selling rate to $, £, euro, Yen or SFr. stands.
   126. With a bar code scanner and/or a recognition sensor equipped EK can over the AIORK software directly the price on the display indicate let to FP-sensor payment transaction authorizing and/or management.
   127a. The AIORK software can manage beside RFID also W-LAN and Bluetooth tags, i.e./turns off personally codes/to initialize and with the re-find by the Friend Finder software an alert to a Web platform or a mobile phone on naturally send. The AIORK software can the sequentially changing recognition-codes of the RFID, W-LAN and Bluetooth tags individually recognize, thus these not by other RFID, W-LAN and Bluetooth receivers and/or AIORK Friend Finder soft goods to be pursued be able. The Friend Finder application can also directly at the Hot Spot, where an identification of a looked for property/product found instead of again a new search starts, as on the AIORK Software from locally people present an inquiry makes itself over GSM/UMTS/Bluetooth/W LAN/NFC.
   127b. The AIORK software can recognize at the same time disturbances of GSM, RFID W-LAN and Bluetooth jammer and convey by means of such signals the existence/use/use of such jammers. In particular if directly several (Bluetooth pica) nets are disturbed, there are alerts to police and mobile phone owners. Can also on obvious other vehicles or mobile phones alarm conveyed, whereby each time, if a vehicle is announced not correctly and/or v.a. is not logged out correctly, because it was stolen, gives it an alarm of the other vehicle or passing humans with its mobile phone with Bluetooth and GSM module.
   127c. The AIORK software can initialize for radio locks the new Downloads.
   128. The AIORK software can select for M-Payment equipped RFID/Bluetooth, W-LAN tags and/or chips with EEOPROM Cache and M-Payment transactions secures implements, as by the owner/debtor a pin code is entered into the AIORK software.
   129. The AIORK software looks for itself the most suitable transaction mode is always that safe NFC or less safe 125 kHz. Bluetooth. IrDA. W-LAN.
   130. Finger-print sensors an the extension kit can be operated also from left to right as only from top to bottom.
   131. The AIORK software managed food and/or packing after their nutrition value and adds the daily, weekly meals directly in the shop starting from the package insert, as with the rack one RFID day with the product specifications is appropriate, where the customer can pick the data out with the mobile phone etc. or it can read off and over the GSM net query it with a pin from the product.
   132. The AIORK software managed kilometres conditions, gasoline, oil consumption and conveys these from the vehicle and/or the central engine control device with Bluetooth transmitter and registers all data over driver, driving fashion, consumption etc. and conveys these daily and/or when each starting and turning the car off with the AIORK software of the driver to the LOCK LOOP Web platform, whereby the data are always conveyed by vehicle and driver.
   133. With the AIORK software ignitions and doors over NFC, Bluetooth etc. with biometric finger-print sensor person recognition become opening and starting managed with motorcycle and vehicle, as it was actually already held with the locked lock box in the LOCK LOOP patent. At the same time the AIORK software takes over the connection to the free intercom or Head set and to the central engine. An extension kit with AIORK software can be kept direct by doors and ignition and be put after the start on the loading station, where still more exact driving specific data are exchanged. The door can be opened automatically, instead of only unlocked with NFC/Bluetooth even equal.
   134. The AIORK software regulates the tree intercom in car and house or elsewhere. In particular in the car the AIORK software switches modules for discussions or Downloads from the mobile phone to the car GSM around the mobile phone accumulator to save to be able.
   135. The AIORK software has a coding that with mobile phones etc. with NFC vehicle etc. of locks with RFID coding and/or safety mechanism the locks cannot be cracked. For this the NFC transceiver ID number will know particularly queried and/or sent and anyway only with LOCK LOOP AIORK soft goods these locks again to be addressed, whereby each mark a report is made the mobile phone of the owner, is over NFC, Bluetooth or GSM.
   136. Over AIORK software can Bluetooth, W-LAN, NFC transmitter in electronic device with AIORK alarm system software powered to become, so that these devices when starting or turning off and or during the use every few seconds, whose identification number sends, so that this registers this identification number with the next mobile phone call of possibly having other mobile phone over the GSM net on our LOCK LOOP Web platform is led, of where from an alarm to (mobile phone) the owner is conveyed, 140. The AIORK software can be adapted on the different condition kind for in particular M-Payment in Europe, the USA and Japan. In a central unit permissions for user, partner companies, become provider data etc. be managed.
   137. Of course the AIORK software is in direct group with the LOCK LOOP data security solutions for locks and/or here also for the key, which can become only with biometric Authentication for the different AIORK applications gemanaged. In particular that an electronic purse cannot be tracked any longer and not used except over the own biometric Authorisation is singularly.
   138. The AIORK software makes it possible to each user directly over Bluetooth, NFC, to load W-LAN news on its mobile phone/MP3-Player down.
   139. Further freelancer can write new AIORK software partial versions, whereby they receive percentages of profits for this, completely after success of the software. Every one of these installed soft goods is initialized with the use and examined thereby, which AIORK of patent right functions is used. Thus Bluetooth chip numbers or other hardware of components, telephone numbers, name, manufacturer soft goods with licenses is examined. Thus it is ensured that the best, dominant factors soft goods are only used and that no other bad AIORK soft goods on the mobile phones etc. to run.
   140. The AIORK software can be adapted on the different condition kind for in particular M-Payment in Europe, the USA and Japan. In a central unit permissions for user, partner companies, become Provider, data etc. gemanaged.
   141. During a registration of a vehicle or a product with Bluetooth Transceiver in a group to the safety device before theft by the announcing Bluetooth radio lock is made each surrounding vehicle or product (Bluetooth) a call with code transmission, so that each calling radio lock exchanges itself individually with already announced the having radio locks and itself identified and/or the their security-codes exchange themselves, which make it possible that only always two radio locks have same security code and not third with one in connection sit down, so that it spends itself as one. Here each minute between these two radio locks an attendance supervision is made, by different themselves with their secret at the beginning at the same time and/or temporally differently shifted successively under all radio locks assigned had having security codes into contact step and their presence confirm. Thus it can be prevented that evenly a third spying radio lock spends itself in such a way later and/or as such camouflaged as an announced and/or as announcing radio lock, so that the announcing radio lock with a jammer can be never blocked and stolen.
   142. The AIORK-software cannot only over pin-codes or fingerprint-sensors in mobile phones etc. Bluetooth- etc. radio-attract be paired, but rather be paired also for vehicle- and other robbery security systems its registrations and recognitions codes so that they simultaneously are exchanged between the Bluetooth modules. With the pin or fingerprint can as well be used as authorisations for pairing with other mobile phone etc. radio lock combinations. These pairing log on always directly or time shifted in the first GSM-net the curl-loop platform transferred.
   143. The AIORK-software will turn off a Bluetooth, NFC in each telephone call or. Make WEAN, 125 KHz or of other transmitter in a device a query to 211 surrounding tranrmitters, stolen transfer and the ID-numbers of the transmitter-chip over the GSM-query directly on our curl-Loop-Web-sites, with that registered devices and/or further per alarm-SMS to the mobile phone of the owner.
   144. For online-internet authorisations, authentications or confirmations becomes with fingerprint-sensor the confirmation over the AIORK-software of the device over an encrypted Bluetooth, W-LAN or NFC connection over a computer for the protected accesses on the servers and files in patent offices etc. possible.
   146. The AIORK software can support mobile phone and other PDA-beamer which use a movable micro-mirror in the pocket format and build up with it the picture to be projected line by line and project then on a wall or in the space or on glasses.
   146. The AIORK-software can simulate passive over a RFID-block-chip vis-à-vis the harvest device a sheer endless number address able RFID-labels, that can be queried impossibly everyone after each other, or can actively the reading of the RFID-chip stop by a interruption signal on this RFID-frequency.
   146. Tbay: Carrier and go (request-offer-auction) Internet- or WAP-platform (for passengers, cyclists, taxi-business, train and flight-companies) which so can be described: State of the art is Ebay an internet-WAP-auction-platform for products- and for persons-carrying, however without (realtime) GPS and GSM-data capture and transmission. For the orientation of the persons, there are new GPS orientation-and-GSM-orientations and display-technologies which enable a new service of the cheapest offer-demand auction for the person's carrier. In Ebay, it is not yet possible to grasp directly the place (a mobile phone) a bidder or a customer in an internet-WAP-platform on a card or a list and let run an auction for the offering of the cheapest carrier. Other carrier-sharing opportunities-platforms with auction function also not yet use the direct GPS GSM location detection and/or input means. Taxi-enterprises do also not yet operate such digital GPS and GSM location-tracking-systems in order to pick up directly their customers. There are sure fleet tracking and managing systems where an operator can announce a location, where a package will be picked up, but this systems runs not for persons and wherein the persons-location-confirmation will be managed over a device with fingerprint-sensor.
   147. Device with fingerprint-sensor for a direct estimation and for the access on an internet interactive and/or mobile-phone-portal with video hit-list hit-chart and/or hit-parade, content, TV canal, game, service, products, software-implementation, authorisations, polls, rights and duties, partner-meeting, trades, economies with direct payment-transaction-service possibilities, which can be described as follows: this AIORK invention runs a mobile-phone portal over retrievable interactive mobile devices, wherein the contents will be rated by direct download. State of the art is MMS pictures that are sent interactively from mobile-phone to mobile-phone. Yet there is no use and/or is described yet none service, that defines a performance of multiple uploaded video-contents that are listed simultaneously interactively in a (hit parade) list on a portal. Of course there is Internet hit parades on WAP, which are however not interactive and are not listed through the number of hits by mobile-phone calls. The AIORK describes the further development of the invention EP 0903676. State of the art is this patent of Sun Micro System (EP 0903676) from the year 1999, which describes such a video hit list on computers. It does not describe however the interactivity and especially that on mobile-hones these video-Clips are observed. Of course have mobile-phones also eine CPU as a computer, but the main independent claim of the Sun patent referees to computer apparatus comprising a computer having a. a display, b. a database of video images, and c. a user interface, running on said computer for presenting a selected representative image of each video presentation stored in said database and identified as relevant to a user query, in a respective cell of an array of images of reduced size. It is being mentioned that “a user interface, running on said computer, for presenting . . . ” Run on the computer. Our video-contents run on mobile-phones and are presented also there whereby the mobile-phones, PDAs, laptops run on their own CPUs and/or computers and they list themselves no hit parades list download after that. Our servers (computers) do need no display what actually the first difference is to the Sun-MS patent, because our hit parades will be displayed on the mobile-phones and they become especially the hit-lists rated with fingerprint-sensors on the mobile phones. The second much more important difference to the Sun-MS patent comes in the independent claim 15 to the light Sun-MS describes only that it is carried out by a network with a server and that a search engine seeks the clips on a server and presents them in a hit-list. It stands nothing therein that the clips are sent interactively on the server or are already input on that in hit-list by other selection mechanisms or that they become v. a. by the hits themselves listed, which were rated again with fingerprint-sensors on the mobile phones. It does not stand or show that the mobile telephones the clips on the one hand without hit parade-list, but rather and on the other hand only with an array. Sun-Microsystems has forgotten in their patent EP0903676 in the claim 16 this simplest function that will be coming at last in the future to the use, that only submits/uploads by the mobile phone out of no search queries to a server are Successful, and however the hit-lists already on the server through other search queries and/or only already through the hits themselves, which are to be rated especially only and uniquely with fingerprintsensors. —A large and wide v. a. Internet patent of Sun Microsystems. Unfortunately they have not thought and/or led a logical reasoning on the mobile-phone to an end and so they have left open a space and/or have that not closed. They claim a hit parade of the most hits (hits) after that which is sought criterion. But very decisively they do not claim (the) “hit”-lists, that usually selected video in a hit parade, also it that can be a sought criterion itself. In this special case, also only the hit parade-lists would be sent, but not the contents of the hit parade (e.g. the video on place 1, 2, 3 . . . ) what is only asked by the consumer! Last but least most important and moreover there is no need of the user submitted search queries, because the best videos are delivered and listed always simply already by VJs, which pre-selectionize them in special categories hourly, daily, weekly. In the Internet, this Sun-MS patent has no commercial effect and only operated on a mobile-phone portal it will have success, because this can be made only by telecom-operators, which need a license and demand so a payment also from the consumer! Moreover with fingerprint-sensors in the mobile phones or computers, best people-related hit parades can be generated to purchase and consummations of contents.

1. This claimed “All In One Remote Key” (AIORK) is comprising a device like a mobile phone, MP3-player, watch or an extension kit with a fingerprint-sensor or with an other biometric identification medium with all interfaces for their interfaces as hardware as well as software for access, number, password, identification, authentication, authorisation with an optional memory, display, key pad, microphone, high-speaker, CPU, accumulator, solar-panel, camera etc. and/or such an extension kit that over software- and software-interfaces mechanically and/or electronically with radio transmission is connected and/or with one software and/or with one list with a GSM-, Bluetooth-, NFC-, W-LAN-, UWB-, IrDA-, 125 kHz- or other 10 cm-100 cm short-distance-transceiver-, radio- and TV-transceiver different electronic and mechanic keys run as software and applications for (following dependent and independent claims):

2. “All In One Remote Key” (AIORK) according to claim 1, wherein the management, the opening, the closing and the starting or the access, the use as interface key, i.e. for a part function, additional information the authorisation or the tracking of one or multiple bicycle- or motorcycle-, vehicle-, home-, garage- or other mobile or firm radio-locks, starters or ignitions run, wherein the unit-codes of the communication transceivers pair their codes, i.e. the keys simultaneously or not pair and wherein with a directional antenna—over all with Bluetooth, NFC or W-LAN the direction to the next transceivers or tags are displayed, wherein additional or over all over a directional antenna the shortest distance or at least the least slave-transceiver to access the desired transceiver or tag is calculated and displayed and wherein over an other intelligence time, location and other slaves are registered and wherein with moving sensors over a Bluetooth or other scatter net and GSM an alarm is transmitted on a mobile phone platform or on the mobile phone of the owner and tracking or emergency alarms run with tracking displaying over GSM mast tracking or GSM-module and -software tracking.

3. “All In One Remote Key” (AIORK) according to claim 1, wherein access-control applications with bidirectional direct simultaneous photo and personal data display for controlling of persons, entrance or transactions for money, mail parcel exchange, wherein with biometric fingerprint-sensors over NFC, Bluetooth etc. the authorisation and the clearing is made and wherein with vehicles with their central engine controlling or -hard- and -software or for controlling of engines- or other service settings etc., devices like laptops, television sets, washing machines etc. or installations for power-, telephone-, radio-nets, central service units, and terminals will be read, identified or be reconfigured of the protected service data and wherein of the device with fingerprint-sensor over Bluetooth, NFC or an other transceiver a safety code CO will be transferred to a hidden ignition with confirmation of the safety code CO and after authorisation of CO over NFC a second safety code C1 to the central engine controlling wherein the fingerprint-sensor in the device will be authorized so that then with authorisation CO1 a further security code C2 of the device with fingerprint-sensor to the ignition, central engine controlling and e.g. to the engine for the starting is transmitted, wherein a Lock-Loop radio-lock with GSM-module and e.g. Bluetooth are part of the safety code system C.

4. “All In One Remote Key” (AIORK) according to claim 1, wherein mobile payment transactions run, wherein with NFC, W-LAN, UWB, Bluetooth- or other e.g. 125 kHz transceivers in a device like mobile phone, watch, MP3-player or one with that device connected extension kit with biometric personal identification as e.g. with a fingerprint-sensor with the bringing in close proximity or direct touch of such a device with an other device or a cash register or vending machine, ticket machine, juke box or gates etc. a payment or micropayment is triggered, wherein direct or indirect with a immediate or later GSM and IMEI-number as well as personal data, biometric data and account-number-data transactions of this device are cleared with that communicating payment terminal on a bank account, wherein
location-, time-, space-, right-consummations like e.g. parking fees, tax fees or entrance prices are cleared directly over this transceiver
rental-, purchase-, sale-, game-, betting-, stock-transactions and insurance policies and contract-forms will be authorized over the Internet and a webplatform or directly.
Internet direct-payment authorisations with AIORK- and personalized fingerprint-security-code for the clearing of payment checks, checks for clearing approval and e-commerce with micro- and macro-payment over Internet connected computers, mobile phones and terminals
acoustic and palpable biometric Fingerprint-sensor rules with one-, two-, three-time touching or sliding or that on the display of the device the prices, the product, lists, groups for quick m-payment is preinstalled and displayed
home banking on the mobile phone, smartphone and PDA as well as computer will be managed and confirmed with NFC-transceiver triggered and with fingerprint-sensor authorized transactions.

5. “All In One Remote Key” (AIORK) according to claim 1, wherein RFID-tag applications run with following functions and features:
over the device will be loaded a RFID-tag with money or a credit, wherein the EOPROM cache memory spaces of the RFID-tags will be read as well as loaded, wherein only the same devices or only the vending machines or the same mobile phones with the same tags can be loaded or with biometric identification over a fingerprint-sensor the tags with the credits will be unloaded and the RFID-credit-tags will be safe like in the Lock-Loop solution with a safe bank-account-number be secured and managed over a over GSM mobile phones.
over the device the RFID-tag numbers in products, ads, logos or packings directly with a GSM-net connection on a web-site will be registered and be managed, wherein the personal registration of the RFID-tags on a web-site will be confirmed with devices with fingerprint-sensors.
clarification over ownership, property and the characteristics of a product with the RFID-tag will be made over a GSM-net connection on a registering web-site.
security spaces of smart-cards or other RFID-tag will be written or identified
in their kind similar applications like food or other consummation calculations run as data base solution

6. “All In One Remote Key” (AIORK) according to claim 1, wherein for natural as well as legal persons simple or multiple general polls, electronic signatures and electronic forms and encrypted PGP emails, certificates, registered letters, mail parcel delivery, tax forms, ticket management, plaints or complaints or patent filings and applications and SAP-working clearings and SMS-ticket-purchase as well as electronic accounting run and which contain time, location, legal data about the use of the device or with another device and the fingerprint-sensors with Bluetooth, W-LAN, NFC etc. transceiver or software management and/or which are cleared on a web-site with a connection to an account directly or indirectly over a GSM-net or other Internet W-LAN connection.

7. “All In One Remote Key” (AIORK) according to claim 1, wherein personal settings of ones preferences for home, vehicle, buyer-behaviour, club-life or for add-filters over Bluetooth etc. run, wherein according to the settings of ones preferences the devices set the media, mobile phone, TV-set, computer, headset or vehicle with engine-management over the central engine controlling to these settings of ones preferences with or without fingerprint-sensor activation or authentificaton and wherein registrations are feasible of all surrounding active transceiver-slaves and -settings on the personal desired or legally enforced safety areas and Bluetooth multi-cast functions run for assignments, games, polls, presentation checks for pupils, students, soldiers, employees etc., which are managed over fingerprint-sensors.

8. “All In One Remote Key” (AIORK) according to claim 1, wherein only for the transaction to value added web-sites the direct authorisation and payment over a fingerprint-sensor confirmation and/or form a RFID-tag with such a link run. I.e. for products with EPC-RFID-tags Internet links can be opened over mobile phones for checking and for offering of the same or similar products in other stores or Internet or normal auctions.

9. “All In One Remote Key” (AIORK) according to claim 1, wherein for on TV-sets or on mobile phone received TV-channels over Bluetooth interfaces and over their setting at the device with a fingerprint-sensor interactive polls, estimations, regulations for adds, broadcasts, sales with “pay per view” and with the new TV-content downloads platforms on 3G mobile phones etc. can be managed, which can be entered in the device with the fingerprint-sensor immediately or like or with an SMS.

10. “All In One Remote Key” (AIORK) according to claim 1, wherein the mobile phone-user decides whether he wants to renounce on the mobile-payment application, because on mobile phones with AIORK-software other applications or software will be blocked proprietarily if the AIORK-software recognizes, that on the mobile phone other unknown or concurring applications run or are used. I.e. the AIORK-software is checking if other software is communicating with any transceivers, which will be selectively blocked from the second attempt. Over all with NFC and mobile payment applications, so that any mobile-payment concurrence and alternative market can be blocked.

11. “All In One Remote Key” (AIORK) according to claim 1, wherein a device with a fingerprint-sensor for access on a transport- and hitchhiking- or request-offer-auction Internet-WAP-platform with or without auction function on a display of a computer or of a mobile phone departure location, time and route to a final destination are shown and can be managed with additional option about area or further precise input features for the improvement of the precision of the time and space, wherein over a digital Internet-WAP-list and/or map over GPS or GSM-nets these offers will be calculated for automobilists or taxi companies or private or public transportation companies, wherein these managements will be authorized, confirmed, cleared and paid over a fingerprint-sensor on the device.

12. “All In One Remote Key” (AIORK) according to claim 1, wherein a device with a fingerprint-sensor for direct evaluation an for access on an interactive Internet or mobile-phone-portal with video hit-list, hit-chart or hit-parade, content, television-channel, game, service, products, software-implementations, authorisations, polls, rights and duties, partner-meeting, trade- and payment-transaction setting-possibilities or clearings run, wherein
a) it interactively with video-clips and contents of other computers, servers, mobile-phones, PDA's, laptops after authentifcation and/or authorisation with biometric fingerprint-sensors is being transferred on these servers, and that
b) the video-clips and contents from these servers back on mobile-phones, PDA's, laptops etc. will be downloaded with biometric person-recognition- and -rating, and that
c) the video-clips and contents from interactive hits of the mobile-phones, PDA's, laptops etc. in hit-charts with biometric person-recogniton and -rating will be listed, and that
d) the hit-charts daily, weekly, monthly und annually will be listed new and according to its termination of the time in the next higher time hit-chart-list will be transferred
e) only toppositions or interactive chosen positions or dips with the chosen title and names of the interactive channels can be downloaded, and that
f) the cost-value-clearings of the clips will be linearly by a factor and by the numbers of hits or reciprocal by a factor on the position on the hit-chart or otherwise according to time, location, quality be charged as the general ground payment-rating-system, and that
g) the clips with special software after upload or after listing will be improved, corrected, encrypted, selectionized according to ones own or general interest and they will be in different lists interactively from the user himself and/or mobile-phone and/or the software be managed and run over fingerprint-sensor-authorisations, and that
h) the portal has an interactive open-source-software for implementations or authorisations for never-ending better software-applications for the portal to receive or to guarantee, which run over fingerprint-sensor-authorisations, and that
i) the portal an interactive radio, and television-Channel participation-, setting- and rating-system will have, which over fingerprint-sensor-authorisations run, and that
j) interactive authorisation-systems for content, events, locations, times, services, duties and rights over fingerprint-sensor-authorisations will be feasible, and that
k) interactive game and/or economic with virtual “Robel” and/or real money run, which with the interactive content inputs will be paid or after used and calculated benefit and value according a payment-rating-systems, and that
l) interactive payment-transactions and billing of contents, auctions, products, services, contests, bids, tickets and tips run, and that
m) interactive encrypted money or bank-transaction management, account- and stock-exchange administration over fingerprint-sensor-authorisations will be feasible, and that
n) interactive encrypted poll-functions for decisions within and outside of the portals run, and that
o) interactive encryption of contents fingerprint-sensor-authorisations will be feasible, and that
p) interactive neuronal-net functions for the interactive settings of the portals will be feasible with fingerprint-sensor-authorisations, and that
q) interactive partner-meeting, -presentations and -games over fingerprint-sensor-authorisations will be feasible, and that
r) traffic-security, -emergency-, next hospital, police, garage, station, tow away, map and guide, place- and acting-locations services over fingerprint-sensor-authorisations will be feasible, and that
s) interactive location and rayon definition authorisations for friends, supporters or law-enforcement and police over fingerprint-sensor-authorisations will be feasible.
